(19) United States
(12) Patent Application Publication
(10) Pub. No.: US 2014/0368746 A1
(43) Pub. Date: Dec. 18, 2014

(54) PROJECTOR

(71) Applicant: SEIKO EPSON CORPORATION, Tokyo (JP)

(72) Inventor: Nobuo SUGIYAMA, Azumino-shi (JP)

(73) Assignee: SEIKO EPSON CORPORATION, Tokyo (JP)

(21) Appl. No.: 14/285,037

(22) Filed: May 22, 2014

(30) Foreign Application Priority Data
Jun. 14, 2013 (JP) 2013-125325

(51) Int. Cl. H04N 5/74

(52) U.S. Cl. CPC H04N 5/7416
USPC 348/759

(57) ABSTRACT

A projector includes a lamp, a ballast, an aperture member including light-blocking plates, a light-blocking plate driving motor, a control section, a light modulation device, and a projection optical system, and the control section controls the ballast and the light-blocking plate driving motor so as to modulate the lamp power based on a luminance of the video signal while fixing the aperture of the aperture member to a constant value in a picture period in accordance with a luminance parameter corresponding to a video signal group in the picture period among a series of the video signals.

### BACKGROUND

1. Technical Field

The present invention relates to a projector.

2. Related Art

In the past, there has been known a projector as one of display devices. The projector modulates light from, for example, an illumination device with a light modulation device to thereby form an image, and then projects the image on a screen with a projection optical system. In the projector, there has been proposed a technology for controlling the intensity of the light emitted from a light source with a dimming device to thereby improve the contrast of the image (see, e.g., JP-A-2010-243976 (Document 1) and JP-A-2010-211035 (Document 2)).

In the projectors of Document 1 and Document 2, the dimming device is provided with a light-blocking member for blocking at least a part of the light from the light source. The light-blocking member moves into and out from a light path in between the light source and a light modulation device. The intensity of the light to be blocked by the light-blocking member out of the light from the light source varies in accordance with the position of the light-blocking member. As a result, according to the projector, the intensity of the light entering the light modulation device can be controlled.

As described above, the dimming device used in the projectors of Document 1 and Document 2 is for mechanically driving the light-blocking member to control an amount of the transmitted light. However, since there is a limitation in the operation speed of the light-blocking member, there is a problem that the light-blocking member cannot sufficiently follow the change in luminance, and thus correct dimming cannot be performed in the case in which the rate of the change in luminance of the picture is high. Further, there is a problem that the noise is increased in the case in which the operation frequency of the light-blocking member is raised in accordance with the change in luminance of the picture.

### SUMMARY

An advantage of some aspects of the invention is to provide a projector capable of correct dimming following a change in luminance of a picture, and of reducing a noise due to an operation of a mechanical dimming device.

A projector according to an aspect of the invention includes a light source adapted to emit light and vary light intensity in accordance with a light source power supplied to the light source, a light source power supply section adapted to supply the light source with the light source power, an aperture member having a variable aperture of a transmitting area through which the light emitted from the light source is transmitted, an aperture drive device adapted to drive the aperture member to control the aperture, a control section adapted to control the light source power supply section and the aperture drive device, a light modulation device adapted to modulate the light emitted from the light source based on a video signal, and a projection optical system adapted to project the light modulated by the light modulation device, and the control section controls the light source power supply section and the aperture drive device so as to modulate the light source power based on a luminance of the video signal while fixing the aperture of the aperture member to a constant value during a certain picture period in accordance with a luminance parameter corresponding to a video signal group in the picture period among a series of the video signals.

In other words, the projector according to the aspect of the invention is provided with both of a mechanical dimming device adapted to drive the aperture member to vary the aperture to thereby control the amount of the transmitted light, and a light source dimming device adapted to vary the light source power to thereby control the amount of light emitted from the light source. Therefore, the projector according to the aspect of the invention easily follows the luminance variation of the picture compared to the projector of the related art provided only with the mechanical dimming device, and is capable of reducing the noise due to the operation of the mechanical dimming device.

Further, in the projector according to the aspect of the invention, the aperture of the aperture member is fixed to a constant, value during a picture period in accordance with a luminance parameter corresponding to the video signal group in the picture period, and the light source power is varied to thereby adjust the amount of the light emitted from the light source. Thus, the followability with respect to the luminance variation of the picture can be improved compared to the projector of the related art, and the operation frequency of the mechanical dimming device decreases, and thus the noise can be reduced.

One of the luminance parameters may be an average picture level in the picture period. On this occasion, the control section can also determine the length of the picture period in accordance with the average picture level.

One of the luminance parameters may be a peak luminance value in the picture period. On this occasion, the control section can determine the aperture of the aperture member in accordance with the peak luminance value. On this occasion, in order to make the aperture of the aperture member correspond to the peak luminance value in the picture period, the aperture of the aperture member is maximized within a light amount control range in the picture period. Therefore, in addition to the improvement, of the followability to the luminance variation of the picture, and the reduction of the noise, there can be obtained an advantage that the amount of the light blocked by the aperture member can be reduced to thereby reduce the heat load on the aperture member.

### BRIEF DESCRIPTION OF THE DRAWINGS

The invention will be described with reference to the accompanying drawings, wherein like numbers reference like elements.

FIG. 1 is a schematic configuration diagram of a projector according to an embodiment of the invention.

FIG. 2 is a flowchart for explaining an operation of a control section.

FIG. 3 is a diagram for explaining a dimming method of the projector according to the embodiment.

FIG. 4 is a diagram for explaining a dimming method of a projector according to an comparative example.

FIG. 5 is a diagram for explaining an operation amount of a mechanical dimming device in the projector according to the embodiment.

FIG. 6 is a diagram for explaining an operation amount of a mechanical dimming device in the projector according to the comparative example.

### DESCRIPTION OF AN EXEMPLARY EMBODIMENT

Hereinafter, an embodiment of the invention will be explained with reference to the accompanying drawings.

The projector according to the present embodiment is an example of a projector provided with three sets of liquid crystal light valves as a light modulation device, namely a so-called three-chip liquid crystal display (3LCD) projector.

In the following drawings, the constituents might be shown with the respective scale ratios of the sizes different from each other in order to make the constituents eye-friendly.

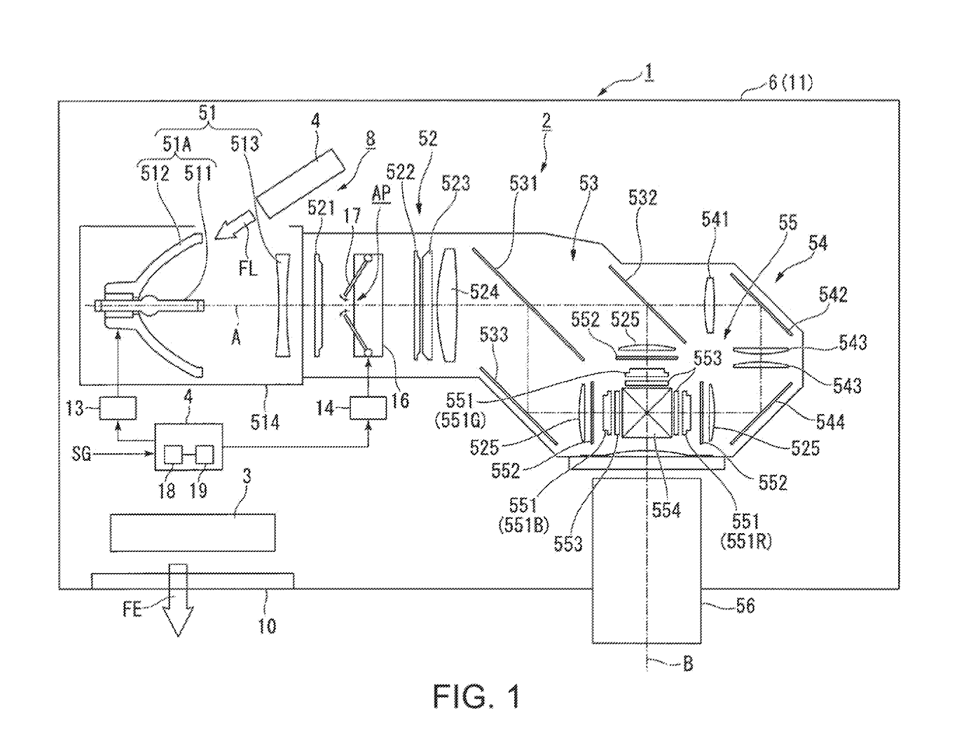

As shown in FIG. 1, the projector 1 according to the present embodiment is provided with an optical unit 2, an exhaust fan 3, a control section 4, and a housing 6. The control section 4 controls a ballast 13 and a light-blocking plate driving motor 14 described later. The optical unit 2 is provided with an illumination device 8, a color separation optical system 53, a light modulation device 55, a color combining optical element 554, and a projection optical system 56. The illumination device 8 is provided with a light source device 51 and a uniform illumination optical system 52.

Hereinafter, the optical unit 2 will be explained.

The light source device 51 emits light toward the uniform illumination optical system 52. The light source device 51 is provided with a light source main body 51A, a collimating lens 513, and a housing member 514. The light source device main body 51A is provided with a lamp 511, and a reflector 512. The lamp 511, the reflector 512, and the collimating lens 513 are housed inside the housing member 514. The reference symbol “A” in FIG. 1 denotes a center axis of the light emitted from the lamp 511, which is referred to as an illumination light axis in the following explanation.

The lamp 511 has an emission center in the vicinity of a primary focal point of the reflector 512. The lamp 511 has a bulb section and a pair of sealing sections. The pair of sealing sections extend on both sides of the bulb section. The bulb section is formed of a spherical body made of quartz glass. The bulb section has a pair of electrodes disposed inside the spherical body, mercury, a noble gas, and a small amount of halogen encapsulated in the spherical body. As the lamp 511, there can be adopted, for example, a ultrahigh pressure mercury lamp, a high-pressure mercury lamp, or a metal halide lamp. The reflector 512 has a cylindrical neck-like portion and a reflecting surface. One of the sealing sections of the lamp 511 is inserted in and fixed to the neck-like portion. The reflecting surface reflects the light, which proceeds toward the reflector 512 out of the light emitted from the lamp 511, toward the secondary focal position of the reflector 512.

The lamp 511 varies in amount of emitted light in accordance with the lamp power supplied. The ballast 13 is connected to the lamp 511. The ballast 13 generates the lamp power in response to a signal from the control section 4, and supplies the lamp 511 with the lamp power. The ballast 13 corresponds to a “light source power supply section” in the appended claims.

The uniform illumination optical system 52 is an optical system for roughly uniformly illuminating an image forming area of each of the liquid crystal light valves 551 with the light emitted from the light source device 51. The uniform illumination optical system 52 is provided with a first lens array 521, a second lens array 522, a polarization conversion element 523, and an superimposed lens 524.

The first lens array 521 has a configuration of arranging a plurality of small lenses in a plane perpendicular to the illumination light axis A in a matrix with a plurality of rows and a plurality of columns. The first lens array 521 has a function as a light beam dividing optical element for dividing the light emitted from the collimating lens 513 into a plurality of partial light beams. Although the explanation using the graphical description is omitted, an outer shape of each of the small lenses is similar to an outer shape of the image forming area of each of the liquid crystal light valves 551.

Similarly to the first lens array 521, the second lens array 522 has a configuration of arranging a plurality of small lenses in a plane perpendicular to the illumination light axis A in a matrix with a plurality of rows and a plurality of columns. The second lens array 522, in conjunction with the superimposed lens 524, has a function of focusing the image of the small lenses of the first lens array 521 in the vicinity of the image forming area of each of the liquid crystal light valves 551.

The polarization conversion element 523 converts each of the partial beams divided into by the first lens array 521 into a substantially unique linearly-polarized light beam having a uniform polarization direction, and then emits the resulted partial light beams. The polarization conversion element 523 has a polarization separation layer, a reflecting layer, and a wave plate. The polarization separation layer transmits one polarized light (e.g., P-polarized light) out of the illumination light from the lamp 511, and reflects the other polarized light (e.g., S-polarized light) toward a direction perpendicular to the illumination light axis A. Further, the reflecting layer reflects the light having the other polarized light, which has been reflected by the polarization separation layer, in a direction parallel to the illumination light axis A. The wave plate converts the light having the one polarized light having been transmitted through the polarization separation layer into the light having the other polarized light.

The superimposed lens 524 is an optical element for collecting the plurality of partial light, beams having passed through the first lens array 521, the second lens array 522, and the polarization conversion element 523 to overlap them in the vicinity of the image forming area of each of the liquid crystal light valves 551. The superimposed lens 524 is disposed so that the optical axis of the superimposed lens 524 and the illumination light axis A of the illumination device 8 roughly coincide with each other. The superimposed lens 524 can also be formed of a compound lens having a plurality of lenses combined with each other.

An aperture member 16 is disposed between the first lens array 521 and the second lens array 522 as the constituents of the uniform illumination optical system 52. The aperture member 16 is provided with, for example, a pair of light-blocking plates 17 each arranged to be rotatable around a rotation axis. The size (aperture) of an opening AP between the pair of light-blocking plates 17 varies due to the rotation of the pair of light-blocking plates 17. Thus, the aperture member 16 can control the amount of transmission of the light emitted from the light source device 51. It should be noted that it is also possible to use an iris-type aperture member provided with, for example, a plurality of aperture blades instead of the aperture member 16 having the pair of light-blocking plates 17, and the type of the aperture member is not particularly limited.

The light-blocking plate driving motor 14 for driving the pair of light-blocking plates 17 is connected to the aperture member 16. As the light-blocking plate driving motor 14, there can be used, for example, a voice coil motor or a stepping motor. The light-blocking plate driving motor 14 drives the pair of light-blocking plates 17 in response to a signal from the control section 4 to control the aperture of the opening AP. The light-blocking plate driving motor 14 corresponds to an “aperture drive device” in the appended claims.

The color separation optical system 53 is provided with a first dichroic mirror 531, a second dichroic mirror 532, and a reflecting mirror 533. The first dichroic mirror 531 and the second dichroic mirror 532 have a function of separating the plurality of partial light beams emitted from the uniform illumination optical system 52 into colored light beams of the three colors of red (R), green (G), and blue (B). The first dichroic mirror 531 transmits the red light and the green light, and reflects the blue light. The second dichroic mirror 532 transmits the red light among the colored light beams having been transmitted through the first dichroic mirror 531, and reflects the green light.

In the first dichroic mirror 531, the red light and the green light are separated from the blue light. The blue light is reflected by the reflecting mirror 533, and is guided to the blue-light liquid crystal light valve 551B. In the second dichroic mirror 532, the green light and the red light are separated from each other. The green light is guided to the green-light liquid crystal light valve 551G. The color separation optical system 53 is further provided with a relay optical device 54. The relay optical device 54 is provided with an entrance side lens 541, relay lenses 543, a reflecting mirror 542, and a reflecting mirror 544. The relay optical device 54 has a function of guiding the red light, which has been separated into by the color separation optical system 53, to the red-light liquid crystal light valve 551R in order to prevent a loss of the red light longer in light path than other colored light beams. Field lenses 525 each convert each of the partial light beams emitted from the second lens array 522 into a light beam parallel to the center axis (the principal ray) thereof.

The light modulation device 55 is provided with three liquid crystal light valves 551 (the red-light liquid crystal light valve 551R, the green-light liquid crystal light valve 551G, and the blue-light liquid crystal light valve 551B), entrance side polarization plates 552 and exit side polarization plates 553 respectively disposed on the light entrance side and the light exit side of the liquid crystal light valves 551. The light modulation device 55 modulates the light, which has been emitted from the illumination device 8 and has entered the light modulation device 55, based on the image signal.

The color combining optical element 554 is formed of a cross dichroic prism. The color combining optical element 554 combines the light beams having been modulated by the liquid crystal light valves 551 of the respective colors. The cross dichroic prism is an optical element for combining the respective colored light beams to form a color image. The cross dichroic prism has a roughly square shape in the plan view formed by bonding four rectangular prisms to each other. On the boundary surfaces having a roughly X shape on which the rectangular prisms are bonded to each other, there are formed dielectric multilayer films. The dielectric multilayer film formed on one of the roughly X-shaped boundary surfaces reflects the blue light, and the dielectric multilayer film formed on the other of the boundary surfaces reflects the red light. The blue light and the red light are respectively deflected by these dielectric multilayer films to have the proceeding direction aligned with the proceeding direction of the green light, and thus the three colored light beams are combined.

Although not shown in the drawings, the projection optical system 56 includes a plurality of projection lenses, which the light having been combined by the color combining optical element 554 enters, and a projection lens housing for housing the plurality of projection lenses.

The illumination light axis A of the illumination device 8 and a projection optical, axis B of the projection optical system 56 are perpendicular to each other. The exhaust fan 3 is disposed in an area surrounded by the illumination device 8 and the projection optical system 56. The exhaust fan 3 is formed of, for example, a sirocco fan. An exhaust port 10 is disposed on the lateral side of the projection optical system 56 among the side surfaces of a lower case 11. The exhaust fan 3 discharges a high-temperature air existing inside the housing 6 to the outside through the exhaust port 10. The flow of the hot air is indicated by the arrow denoted with the symbol FE.

The control section 4 controls the ballast 13 and the light-blocking plate driving motor 14. In the control section 4, a video signal SG input thereto is temporarily stored in a frame memory 19 via a buffer 18. The frame memory 19 preferably has a capacity capable of storing as much video signals as possible. In the present embodiment, the frame memory 19 has a capacity capable of storing at least the video signals SG corresponding to one picture period (e.g., 2 seconds) described later. Besides the above, the control section 4 controls the light modulation device 55 in response to the video signal SG. It should be noted that in the present embodiment, the control of the light modulation device 55 is general, and will therefore be omitted from the explanation.

The projector 1 according to the present embodiment is provided with dimming devices for the purpose of improving the contrast of an image. One of the dimming devices is for controlling the amount of the transmitted light using the aperture member 16 after the light is emitted from the light source device 51. The aperture member 16 has a configuration of mechanically driving the pair of light-blocking plates 17 using the light-blocking plate driving motor 14, and is therefore hereinafter referred to as a mechanical dimming device. The other of the dimming devices is for controlling the ballast 13 to vary the lamp power to thereby control, the emitted light amount of the lamp 511 itself, and is hereinafter referred to as a lamp dimming device.

In the projectors of the related art provided only with the mechanical dimming device, there are a problem of a poor followability of the mechanical dimming device and a problem of a noise due to the operation of the mechanical dimming device. In contrast, in the projector 1 according to the present embodiment, since both of the mechanical dimming device and the lamp dimming device are provided, the followability of the whole of the dimming devices is improved, and the noise can be reduced.

Here, in the projector, in the case of providing both of the mechanical dimming device and the lamp dimming device, the following method can be adopted as the control method of these two types of dimming devices. The control method explained below is a comparative example.

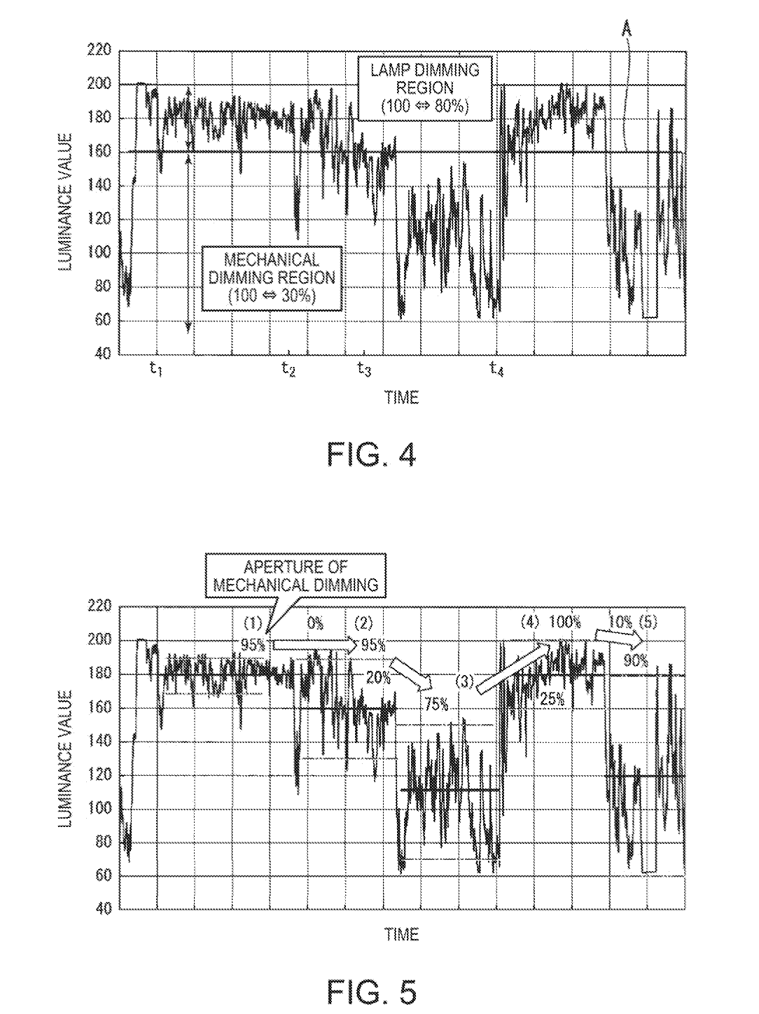

FIG. 4 is a diagram for explaining the control method of the comparative example, wherein the horizontal axis of the graph represents the time (minute), and the vertical axis represents the luminance value of the video signal. The luminance value is an index representing brightness of the picture in each of the video signals, and can be thought to be, for example, a gray level of the video signal. In FIG. 4, there is shown a variation in the luminance value of the video signal in a certain period, wherein the maximum luminance value is 200 and the minimum luminance value is 62. Hereinafter, the explanation is continued using the rate of each of the luminance values assuming that the maximum luminance value of 200 corresponds to 100% as a light control rate.

In the method of the comparative example, the lamp dimming device is made function in a range of the light control rate of 80% through 100%, and the mechanical dimming device is made function in a range of the light control rate of 30% through 80%. The reason that the lamp dimming device is used on the side where the light control rate is high is that the reliability of the lamp cannot be ensured on the side where the light control rate is low, namely the side where the amount of the light is significantly reduced. In other words, in the method of the comparative example, the region the lamp dimming device is in charge of and the region the mechanical dimming device is in charge of are separated from each other depending on the value of the light control rate.

In FIG. 4, the lamp dimming device deals with the dimming in a range above the straight line A, and the mechanical dimming device deals with the dimming in a range below the straight line A. For example, in the period of t₁ through t₂, the lamp dimming device is in charge of roughly the entire period, and in the period of t₃ through t₄, the mechanical dimming device is in charge of roughly the entire period. In this example, in the range below the straight line A, the mechanical dimming device is made to deal with the luminance variation while fixing the light control rate due to the lamp dimming device to 30%. However, it is difficult for the mechanical dimming device to accurately follow such a rapid luminance variation. Further, it results that the mechanical dimming device always operates during the period with the light control rate not higher than 80%, and the noise continuously occurs.

In contrast, the control method of the dimming devices according to the present embodiment is a method of modulating the lamp power based on the luminance of the video signal SG in the state in which the aperture of the aperture member 16 is fixed to a certain value in a certain picture period in accordance with a luminance parameter corresponding to a video signal group in the picture period among the series of video signals.

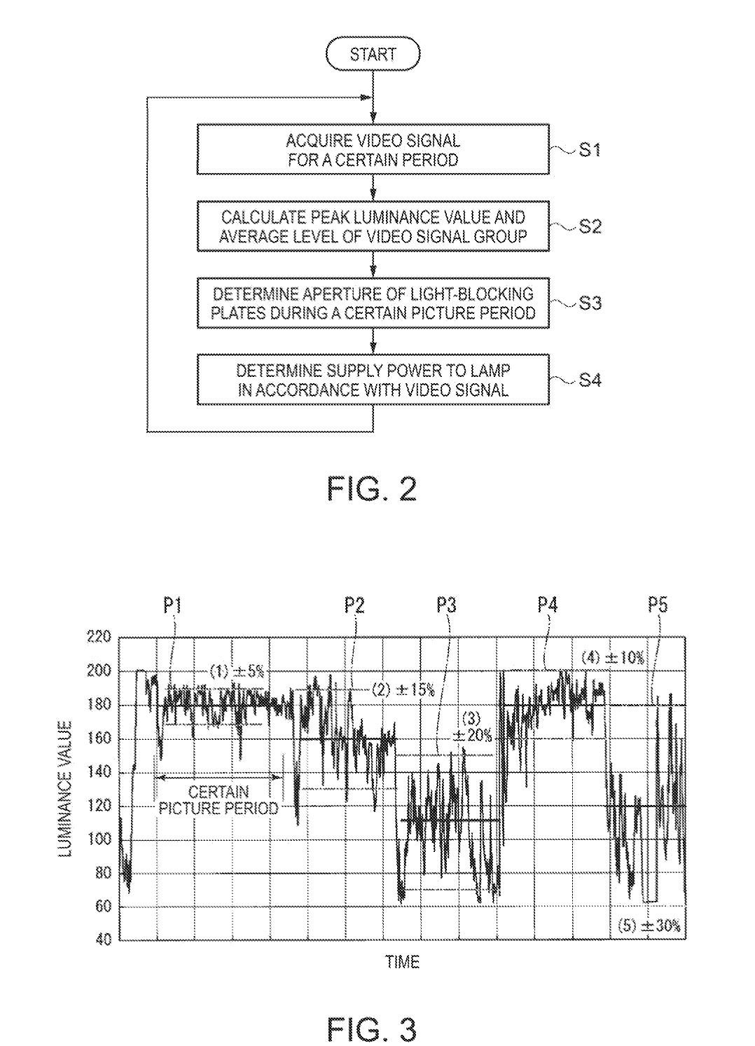

FIG. 2 is a flowchart showing the control method according to the present embodiment. FIG. 3 is a diagram for explaining the control method according to the present embodiment, and the content of FIG. 3 is roughly the same as the content of FIG. 4.

In the control method of the dimming devices according to the present embodiment, the control section 4 firstly acquires (step S1 in FIG. 2) the video signals in a certain period into the frame memory 19 via the buffer 18. The capacity of the frame memory is preferably as high as possible, and is preferably capable of acquiring the video signals SG corresponding to, for example, about several seconds through 10 seconds.

Then, assuming that the frame memory 19 is capable of acquiring the video signals for 10 seconds, the control section 4 obtains an average picture level (hereinafter abbreviated as APL) of the series of video signals SG as the luminance parameter. In the example shown in FIG. 3, the series of video signals SG is categorized into five video signal groups, namely a video signal group with the APL of 180 (the light control rate of 90%), a video signal group with the APL of 160 (the light control rate of 80%), a video signal group with the APL of 1.10 (the light control rate of 55%), a video signal group with the APL of 180 (the light control rate of 90%), and a video signal group with the APL of 120 (the light control rate of 60%) in chronological order.

A period corresponding to one video signal group is referred to as a picture period. The picture periods corresponding to the five video signal groups are referred to as a first picture period, a second picture period, a third picture period, a fourth picture period, and a fifth picture period, respectively, in chronological order. These picture periods can be determined based on the APL.

Further, the control section 4 obtains (step S2 in FIG. 2) the peak luminance values P1 through P5 in the respective picture periods as the luminance parameter. In the example shown in FIG. 3, the peak luminance value P1 in the first picture period becomes 190 (the light control rate of 95%), the peak luminance value P2 in the second picture period becomes 190 (the light control rate of 95%), the peak luminance value P3 in the third picture period becomes 150 (the light control rate of 75%), the peak luminance value P4 in the fourth picture period becomes 200 (the light control rate of 100%), and the peak luminance value P5 in the fifth picture period becomes 180 (the light control rate of 90%).

Subsequently, the control section 4 determines (step S3 in FIG. 2) the aperture of the light-blocking plates 17 in the aperture member 16 based on the peak luminance values P1 through P5 in the respective picture periods obtained in the step S2. On this occasion, the control section 4 applies the light control rate of each of the peak luminance values P1 through P5 in the respective picture periods directly to the aperture of the light-blocking plates 17. Specifically, the aperture of the light-blocking plates 17 in the first picture period is set to 95%, the aperture of the light-blocking plates 17 in the second picture period is set to 95%, the aperture of the light-blocking plates 17 in the third picture period is set to 75%, the aperture of the light-blocking plates 17 in the fourth picture period is set to 100%, and the aperture of the light-blocking plates 17 in the fifth picture period is set to 90%. For example, since the peak luminance value does not vary between the first picture period and the second picture period, the aperture of the light-blocking plates 17 is not varied.

The control section 4 controls the light-blocking plate driving motor 14 in accordance with the aperture of the light-blocking plates 17 to adjust the light-blocking plates 17 so as to have the given aperture. On this occasion, in each of the picture periods, the aperture of the light-blocking plates 17 is fixed to a constant value without following the luminance variation.

Subsequently, the control section 4 determines (step S4 in FIG. 2) the lamp power to be supplied to the lamp 511 in accordance with the luminance variation of the video signal group in each of the picture periods. Specifically, the control section 4 stores a look-up table (LUT) showing a relationship between the luminance value and the ballast output signal corresponding to the lamp power using the aperture of the light-blocking plates 17 as a parameter. The control section 4 reads out an instruction signal, which corresponds to the luminance value, and is provided to the ballast 13, from the LUT, and then outputs the instruction signal to the ballast 13. The ballast 13 outputs the lamp power, which is based on the instruction signal thus input, to the lamp 511.

The light control rate of the lamp 511 is preferably set to a value within a range where the reliability of the lamp 511 is not impaired. The light control rate of the lamp 511 is preferably set in a range of, for example, 50 through 100%, and is more preferably set in a range of 70 through 100%. It should be noted that even in the case of setting the light control rate of the lamp to a value lower than 50%, there is no particular problem providing the period in which the light control rate is lower than 50% is limited to a rather short period. In the example shown in FIG. 3, the light control rate of the lamp 511 is varied within a range of 90 through 100% in the first picture period, the light control rate of the lamp 511 is varied within a range of 70 through 100% in the second picture period, the light control rate of the lamp 511 is varied within a range of 60 through 100% in the third picture period, the light control rate of the lamp 511 is varied within a range of 80 through 100% in the fourth picture period, and the light control rate of the lamp 511 is varied within a range of 40 through 100% in the fifth picture period.

Here, an amount of movement of the light-blocking plates 17, namely the variation in aperture of the light-blocking plates 17 from the aperture in the present picture period to the aperture in the subsequent picture period, is compared between the control method according to the comparative example and the control method according to the present embodiment.

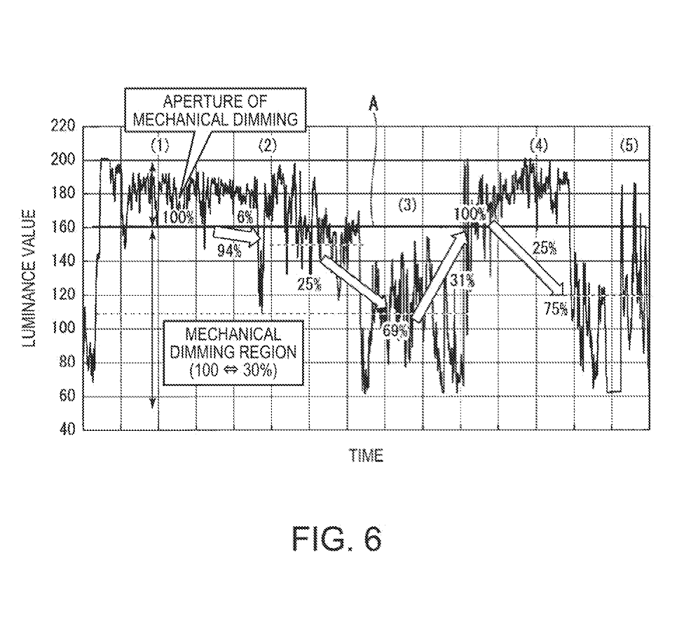

In the comparative example, as shown in FIG. 6, since the mechanical dimming device is in charge of the region with the luminance value lower than 180 (the light control rate of 80%), the point with the luminance value of 180 (the light control rate of 80%) is made to correspond to the aperture of 100%. Further, here, for the sake of convenience of calculation, it is assumed that the light-blocking plates 17 are not driven precisely in accordance with each of the luminance values, but are driven so as to match the APL in each of the picture periods shown in FIG. 5. On this occasion, the aperture of the light-blocking plates in the first picture period becomes 100%, the aperture of the light-blocking plates in the second picture period becomes 94%, the aperture of the light-blocking plates in the third picture period becomes 69%, the aperture of the light-blocking plates in the fourth picture period becomes 100%, and the aperture of the light-blocking plates in the fifth picture period becomes 75%.

In the control method according to the comparative example and the control method according to the present embodiment, the aperture of the light-blocking plates 17 in each of the picture periods, an operation width of the light-blocking plates 17 from the previous picture period to the present picture period, and a difference in operation width between the present embodiment and the comparative example are organized as Table 1 below.

TABLE 1

| | | | | | Difference |
|---|---|---|---|---|---|
| | Comparative | | Present | | between |
| | Example | | Embodiment | | present |
| | Aperture | | Aperture | | embodiment |
| | of light- | | of light- | | and |
| Picture | blocking | Operation | blocking | Operation | comparative |
| period | plates | width | plates | width | example |
| First | 100% | — | 95% | — | — |
| picture | | | | | |
| period | | | | | |
| Second | 64% | 6% | 95% | 0% | −6% |
| picture | | | | | |
| period | | | | | |
| Third | 69% | 25% | 75% | 20% | −5% |
| picture | | | | | |
| period | | | | | |
| Fourth | 100% | 31% | 100% | 25% | −6% |
| picture | | | | | |
| period | | | | | |
| Fifth | 75% | 25% | 90% | 10% | −15% |
| picture | | | | | |
| period | | | | | |

As shown in Table 1, in the comparative example, the operation width of the light-blocking plates from the first picture period to the second picture period is 6%, the operation width of the light-blocking plates from the second picture period to the third picture period is 25%, the operation width of the light-blocking plates from the third picture period to the fourth picture period is 31%, and the operation width of the light-blocking plates from the fourth picture period to the fifth picture period is 25%. In contrast, in the present embodiment, the operation width of the light-blocking plates from the first picture period to the second picture period is 0%, the operation width of the light-blocking plates from the second picture period to the third picture period is 20%, the operation width of the light-blocking plates from the third picture period to the fourth picture period is 25%, and the operation width of the light-blocking plates from the fourth picture period to the fifth picture period is 10%. As described above, it has been found out the fact that according to the control method of the present embodiment, the operation width of the light-blocking plates 17 can be reduced 5 through 15% compared to the control method according to the comparative example.

In the case, for example, of using a voice coil motor (VCM) as the light-blocking plate driving motor 14, the operation time of the voice coil motor necessary to change the aperture from 0% to 100% is about 0.1 second. In the case in which the maximum operation width of the light-blocking plates 17 is 25% as in the present embodiment, the operation time becomes 0.025 second, which shows that the voice coil motor can be used without a problem. In contrast, in the case of using a stepping motor (SM), the operation time of the stepping motor necessary to change the aperture from 0% to 100% is about 1 second. As described above, the stepping motor is low in response speed compared to the voice coil motor, and is therefore difficult to use as the light-blocking plate driving motor 14. It should be noted that in the case in which the maximum operation width of the light-blocking plates 17 is 25%, the operation time of the stepping motor becomes 0.25 second, which is a level allowing the use of the stepping motor.

Then, the operation rate of the light-blocking plates 17 is compared between the control method according to the comparative example and the control method according to the present embodiment.

Assuming that the operation time of the voice coil motor is 0.025 second and the operation time of the stepping motor is 0.25 second in the case in which the operation width of the light-blocking plates 17 is 25% as described above, and the length of one picture period is 2 seconds, the operation rate can be calculated as Table 2 below.

TABLE 2

| Type of | | Comparative | | Present | |
|---|---|---|---|---|---|
| light-blocking | | Example | | Embodiment | |
| plate driving | Operation | | Operation | | Operation |
| motor | time | Followability | rate | Followability | rate |
| Voice coil motor | 0.025 sec | A | 100% | A | 1.25% |
| Stepping motor | 0.25 sec | C | 100% | B | 12.5% |

In Table 2, the symbol “A” represents sufficiently good followability, the symbol “B” represents good followability, and the symbol “C” represents poor followability.

As shown in Table 2, in the comparative example, since the light-blocking plates are always operating during the picture period the mechanical dimming device is in charge of, the operation rate is 100% irrespective of the type of the motor. In contrast, in the present embodiment, it is possible to dramatically improve the operation rate of the light-blocking plates 17 in one picture period (2 seconds) to 1.25% with the voice coil motor, or to 12.5% with the stepping motor.

According to the results described above, in the case of the present embodiment, the voice coil motor can provide sufficient followability as the light-blocking plate driving motor 14. In contrast, the stepping motor cannot be used in the control method according to the comparative example from the viewpoint of the followability, but can be used in the control method according to the present embodiment although inferior to the voice coil motor in terms of the followability.

As described hereinabove, in the projector 1 according to the present embodiment, the aperture of the aperture member 16 is fixed to a constant value during each of the first through fifth picture periods each corresponding to the group of the video signals having a roughly equivalent APL, but is not varied continuously in accordance with each of the video signals. On that basis, in the projector 1 according to the present embodiment, the lamp power is varied during the picture period to thereby control the amount of the light emitted from the light source device 51 to perform the dimming. In general, the lamp dimming is sufficiently high in response speed compared to the mechanical dimming. Therefore, in the projector 1 according to the present embodiment, the followability with respect to the luminance variation of the picture is improved compared to the projector of the related art. Further, the operation width of the light-blocking plates 17 can be reduced, and in addition, the operation rate of the light-blocking plate 17, in other words, the operation frequency of the light-blocking plates, can be lowered. Therefore, the noise can be reduced.

In particular in the case of the present embodiment, since the aperture of the light-blocking plates 17 is set in accordance with the peak luminance value in each of the picture periods, there is created a state in which the light-blocking plates 17 are opened as widely as possible within a range in which the dimming devices are capable of dealing with the luminance value of each of the video signals. Then, the lamp dimming device controls the amount of the light emitted from the lamp 511 in the dimming direction from the maximum value (100%). Therefore, there is achieved the control method in which the amount of the light blocked by the light-blocking plates 17 is the smallest, and the heat load applied to the light-blocking plates 17 becomes sufficiently small. As a result, the reliability of the light-blocking plates 17 as the mechanical dimming device can be improved.

It should be noted that the scope of the invention is not limited to the embodiment described above, but various modifications can be provided thereon within the scope or the spirit of the invention.

For example, although in the embodiment described above, the aperture of the aperture member is fixed in accordance with the peak luminance value in each of the picture periods, it is also possible to adopt a method of fixing the aperture of the aperture member in accordance with, for example, the APL in each of the picture periods, and then increasing or decreasing the amount of the light emitted from the lamp using the lamp dimming device instead of the method described above. Although in this method, there is a possibility that the amount of the light blocked by the light-blocking plates increases compared to the method of the embodiment described above, and the heat load applied to the light-blocking plates increases, it is sufficient to arbitrarily adjust the aperture within the allowable range of the heat load.

Besides the above, the specific configuration of each of the constituents of the projector can arbitrarily be modified.

The entire disclosure of Japanese Patent Application No. 2013-125325, filed Jun. 14, 2013 is expressly incorporated by reference herein.

What is claimed is:

1. A projector comprising:
a light source adapted to emit light and vary light intensity in accordance with a light source power supplied to the light source;
a light source power supply section adapted to supply the light source with the light source power;
an aperture member having a variable aperture of a transmitting area through which the light emitted from the light source is transmitted;
an aperture drive device adapted to drive the aperture member to control the aperture;
a control section adapted to control the light source power supply section and the aperture drive device;
a light modulation device adapted to modulate the light emitted from the light source based on a video signal; and
a projection optical system adapted to project the light modulated by the light modulation device,
wherein the control section controls the light source power supply section and the aperture drive device so as to modulate the light source power based on a luminance of the video signal while fixing the aperture of the aperture member to a constant value during a picture period in accordance with a luminance parameter corresponding to a video signal group in the picture period among a series of the video signals.

2. The projector according to claim 1, wherein
one of the luminance parameters is an average picture level in the picture period.

3. The projector according to claim 2, wherein
the control section determines the length of the picture period in accordance with the average picture level.

4. The projector according to claim 1, wherein
one of the luminance parameters is a peak luminance value in the picture period.

5. The projector according to claim 4, wherein
the control section determines the aperture of the aperture member in accordance with the peak luminance value.
